(19) United States
(12) Patent Application Publication
(10) Pub. No.: US 2003/0195879 A1
(43) Pub. Date: Oct. 16, 2003

(54) Data collection technology useful for form manipulation

(76) Inventors: Arsen Pereymer, Brooklyn, NY (US); Elvis Pereymer, Brooklyn, NY (US)

Correspondence Address: A. David Joran, 25 Crescent Avenue, Passaic, NJ, 07055, US

(21) Appl. No.: 10/120,662

(22) Filed: Apr. 12, 2002

(51) Int. Cl. G06F 7/00

(52) U.S. Cl. 707/4

(57) ABSTRACT

The invention provides a database-driven form manager for building and modifying a form for use in an internet, intranet or extranet environment, comprising means for storing a question in a table of questions; means for storing properties of each respective question; means for storing a group of said questions; means for storing properties of the group of questions; means for referencing association of each question with each respective group; means for selecting questions and associating said questions with a group; means for re-ordering said questions within each associated group based on a group order parameter so as to build or modify said form; means for looping through group questions to extract questions belonging to the group identification; and, means for displaying said form on a display device for use in an internet, intranet or extranet environment.

### BACKGROUND OF THE INVENTION

The present invention relates to a novel method of data collection which is useful for the manipulation of forms used in connection with commerce on a global information network.

Traditionally, forms used for collecting relevant information for conducting commerce on a global information network has demanded significant effort involving the expertise of a database administrator, a midlevel developer or an HTML developer. To make even minor field additions, changes or order changes, the expert needed to spend several hours per simple field or validation. Typically, to make a design change, the database administrator or HTML developer needed to update the database, SQL, program logic as well as the HTML front end. More desirable would be a system of form manipulation which would enable the non-expert end-user to make any required manipulation rapidly without further training.

The present invention provides a quasi-intelligent, language-independent platform technology which, on deployment, permits the display, modification, and manipulation of internet forms, without any changes in the underlying software code. All changes made in a form using the method of the invention are implemented in the database itself. The method of the present invention is based on dynamic logic, and is database-driven, so the form fields do not need to be addressed by a hard-coded name. The present invention also offers scalability, flexibility, and quasi-intelligence with built-in question dependencies, and greatly alleviates the complexities of form development and modification, thereby facilitating data collection in a wide range of applications.

### SUMMARY OF THE INVENTION

Accordingly, the present invention provides a database-driven form manager for building and modifying a form for use in an internet, intranet or extranet environment, comprising

means for storing a question in a table of questions;

means for storing properties of each respective question, said properties including a text for the question and a reference number denoting its question type;

means for storing a group of said questions;

means for storing properties of the group of questions, said properties including a group name, an order parameter denoting the order of said questions and a reference number denoting group identification;

means for referencing association of each question with each respective group, said means being a group question table, wherein said group question table contains a set of group identifications and associated question identifications;

means for selecting questions and associating said questions with a group;

means for re-ordering said questions within each associated group based on a group order parameter so as to build or modify said form;

means for looping through group questions to extract questions belonging to the group identification; and

means for displaying said form on a display device for use in an internet, intranet or extranet environment.

In one embodiment, the invention provides the above-described database-driven form manager, wherein the question identification types comprise text-box, pull-down, list-box, check-box, radio-button or text area.

In another embodiment, the invention provides the above-described database-driven form manager, wherein the text area denotes a question identification type having multiple rows of data.

In another embodiment, the invention provides the above-described database-driven form manager, wherein the question identification type refers to a type of question.

In another embodiment, the invention provides the above-described database-driven form manager, wherein the properties of questions further comprise an explanation or help text, a note or notes comprising at-will comments, and/or an indication of whether the question is required to be answered.

In another embodiment, the invention provides the above-described database-driven form manager, further comprising means for entering answers to the questions.

In another embodiment, the invention provides the above-described database-driven form manager, further comprising means for saving or storing said answers to questions.

In another embodiment, the invention provides the above-described database-driven form manager, further comprising means for selecting possible answers based on expected answer properties.

In another embodiment, the invention provides the above-described database-driven form manager, wherein said answer properties comprise an answer identification, associated answer identification, answer text and answer text parameters.

In another embodiment, the invention provides the above-described database-driven form manager, wherein said properties are stored in a question/answer table.

In another embodiment, the invention provides the above-described database-driven form manager, further comprising a means for associating one or more second form elements with one or more other first form elements, said first form elements being selected by the user priorly to said second form elements, and means for causing said one or more second form elements to be displayed upon the input by the user of said one or more first form elements.

In another embodiment, the invention provides the above-described database-driven form manager, further comprising a means for validating the format of an answer, comprising a means of associating with the form elements of the data comprising said answer the type of data and other appropriate answer properties, and a means of confirming the correctness of each form element so as to permit verification of data purity or validity.

### BRIEF DESCRIPTION OF DRAWINGS

FIG. 1 shows the high-level overview of the form manager in accordance with the invention.

FIG. 2 shows an exemplary implementation of the application architecture for generic form display in accordance with the invention.

FIG. 3 shows (a) the tables of parameters (including the validation parameters, security parameters and dependency parameters) required for operating the form manager and the display of forms in accordance with the invention and (b) complementary utilities tables (for control of appearance, map PDF, query string alerts and notifications) useful for operating the form manager in accordance with the invention.

### DETAILED DESCRIPTION OF THE INVENTION

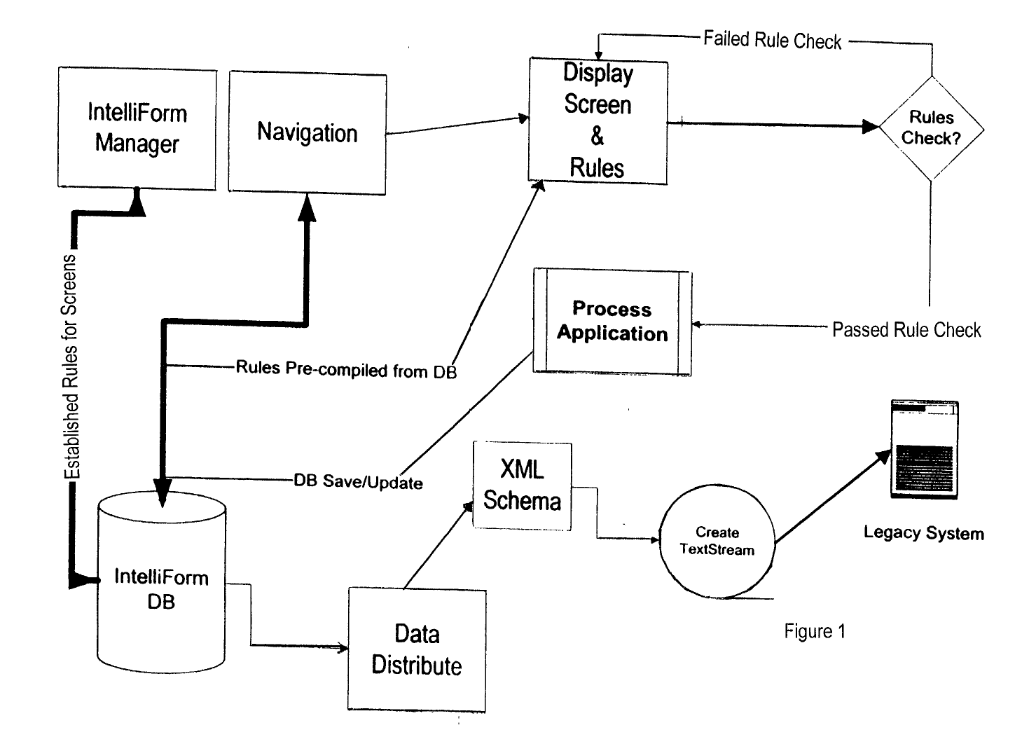

As illustrated in the accompanying FIGS. 1-3, the present invention provides a generic form utility which allows an information technology development group, or specifically a non-technical business person, to quickly and easily design all types of enterprise level or simple forms, which can then be displayed, updated and retrieved in a web-based environment. As used herein, the term “IntelliForm” refers to a form generated in accordance with the form manager of the invention.

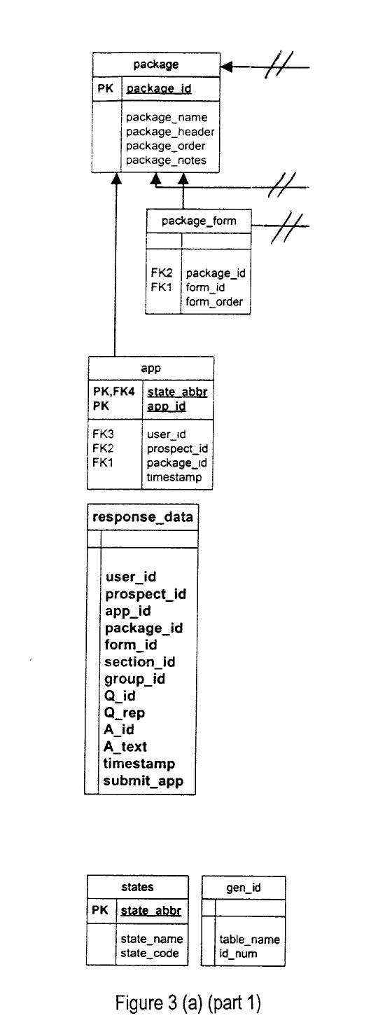

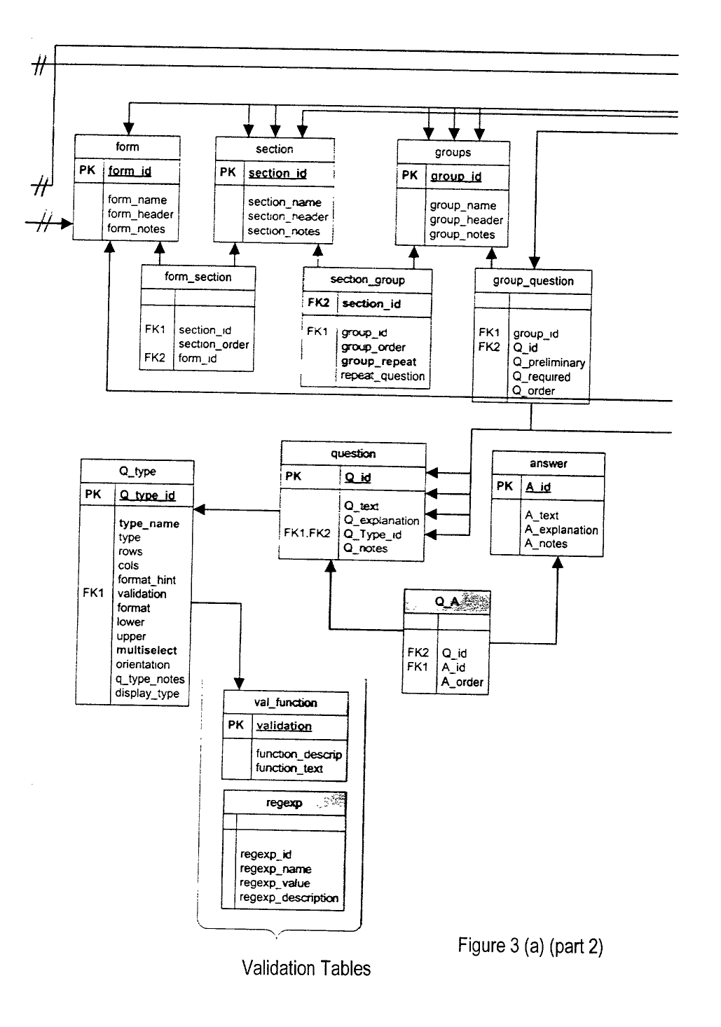

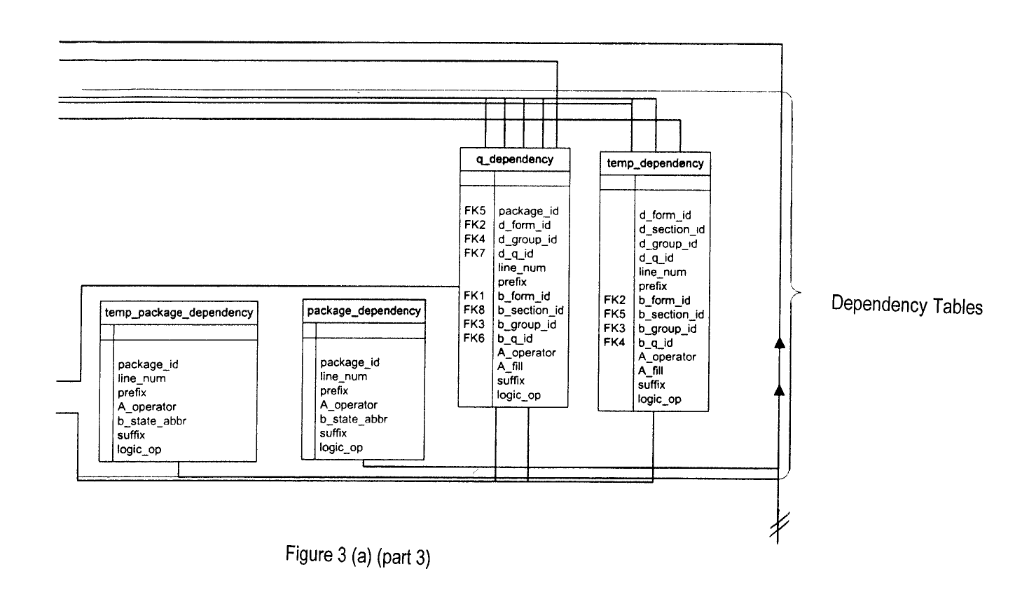

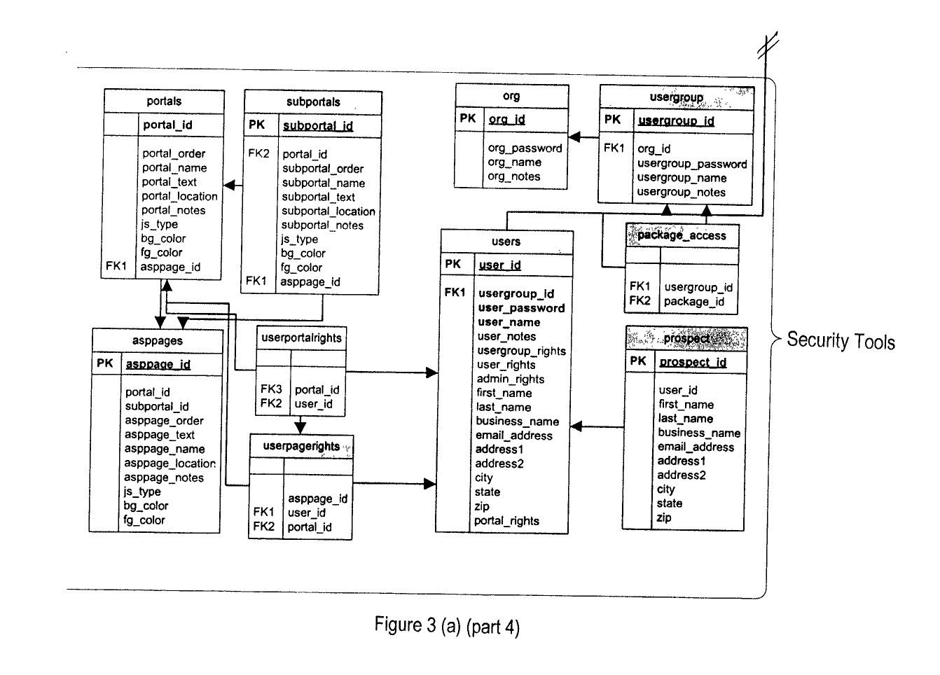

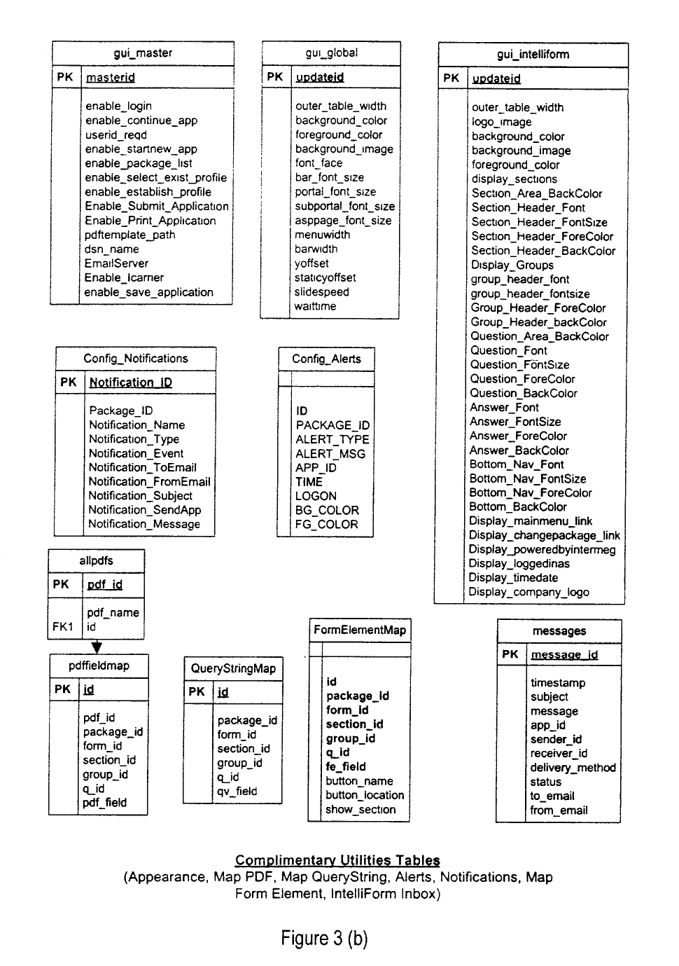

As used herein, a PACKAGE, referred to in FIG. 3(a), consists of one or more FORMS. FORMs consist of one or more SECTIONs. SECTIONs are related to a specific section of a FORM. Each section is comprised of one or more GROUPs of questions. Each GROUP is comprised of several individual questions that are usually presented together. Each select list, radio button and check box QUESTION is associated with possible ANSWERs to be presented to the user. There is provided a facility to give each SECTION, GROUP, QUESTION and ANSWER a priority which will determine the order that they will be presented to the user. This structure permits an information technology group, or specifically a non-technical business person, to quickly and easily add new forms to their intranet, internet or extranet site simply by adding a Section and then selecting the question Groups that are applicable to that section.

Questions can be of the following types: Text Box, Text Area, Drop Down Select List, Check Boxes, and Radio Buttons, as illustrated in FIG. 4. A question definition specifies the question type and other parameters that define the way a question and its possible answers will be displayed. For a Text Box, the question definition includes the width of the field in characters. It also includes: Format—such as, date (in various formats), currency, decimal, etc. (wherein each format is validated upon user entry); Data validation—a logical statement that is used to validate the information that is entered. For a Text Area, it includes the width in characters and the height in lines. For a Drop Down Select List, it includes whether or not it is multi-select. For Check Boxes, it includes whether or not it is vertical or horizontal. Radio Buttons can be vertical or horizontal. Each question much have a question definition associated with it.

Each question may be marked as either “not required”, “required to save”, or “required to submit” form. This will be done at the Group_Question level. A facility is provided to highlight or mark off the questions that are required for saving and those that are required for submission.

The system administrator is able to specify a dependency for a question which determines if that question will be enabled on the screen. The dependency is based on the answer to another question or questions. The question presentation can depend on multiple previous questions connected with a logical ‘AND’ or ‘OR’. Each previous answer in the dependency can be specified to be either equal to a specific answer number or ‘less than’, ‘greater than’, or ‘equal to’ or ‘not equal to’ a specific value. (e.g., ask question 39 if the answer to question 37 is answer #245 AND the answer to question 14 is greater than ‘$25,000’). The question ‘depended on’ is presented prior to the ‘dependent’ question. This relationship is validated by the IntelliForm Manager.

Each Section has a heading. When a Form is selected to be displayed, all Section headings are displayed on the left of the browser window. The questions belonging to the groups in the first Section are displayed on the right. As each Section is selected, the questions belonging to groups in that Section are displayed.

A group can optionally have a heading. If a heading exists, it is displayed before the questions. A GROUP can be specified as repetitive, which means that the questions in the Group are asked multiple times. The questions in the Group is displayed once initially. A button is displayed which, when pressed, displays the same group of questions again. The group heading is repeated with the count of the group repetition displayed following the header (e.g., Information for Driver1, Information for Driver 2, etc.).

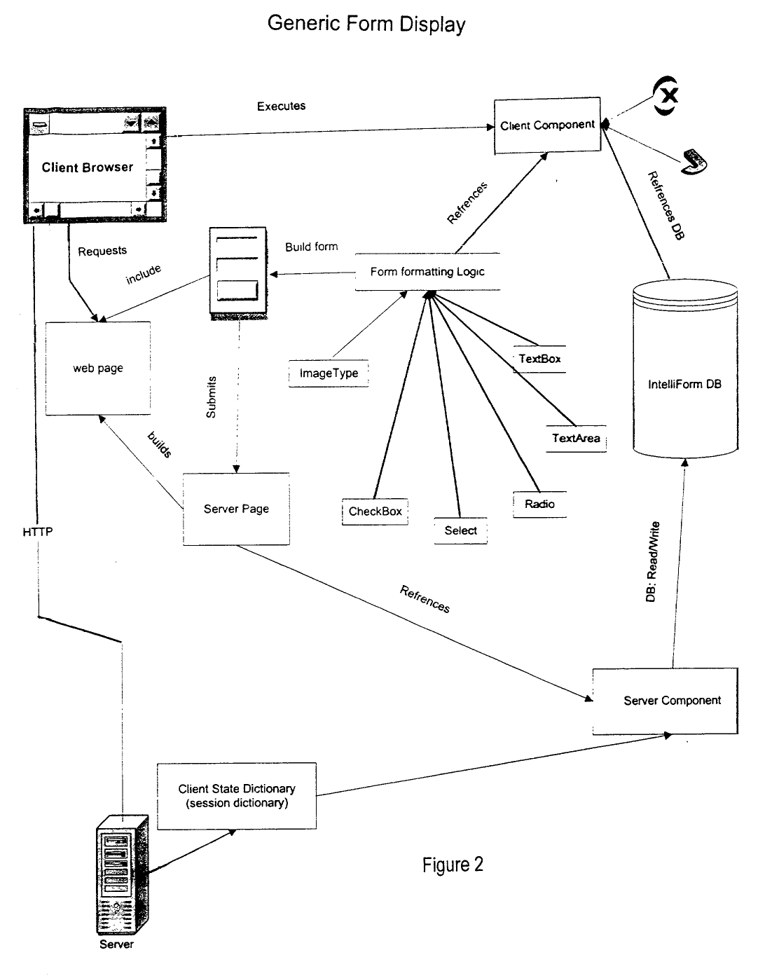

The system administrator is also able to build and re-use validation scripts. Such scripts are built using a suitable language such as JavaScript, and hence they are sent to the browser for client-side validation (e.g., see FIG. 2). Once a validation script is built, it is attached to a q_type, which in turn is attached to a Quesiton.

A Map PDF tool (FIG. 3(b)) allows the administrator to map each data capture field to a PDF field within the selected PDF file. Once a mapping is established for the specific application form, the form manager uses this mapping when the print requests are initiated from the form. The Map PDF tool contains the functionality of adding a PDF to the database, modifying a PDF file's properties, removing a PDF from the database, creating a new mapping, updating a mapping or deleting a mapping.

An XML Schema Builder (FIG. 1) optionally permits the administrator to perform a number of functions for each application form, including creating XML schema, as well as modifying and removing them. Once XML schema are established, they may be used to the XML file for the associated application form. Such a file may be generated based on the settings of the Data Exchanger tool.

The user is given the opportunity to save the parts of the questionnaire they have actually completed and return to continue or complete the form at a later time. When returning to review a form, the user is given the choice to either review the entire form or only the questions that were not completed.

Upon completion of the form, the user is able to submit the information to an appropriate Application Engine which will process the form contents in an industry specific manner.

An IntelliForm Manager, referred to in FIG. 1, is used to manage the form manager's questions, answers, and question dependencies. The IntelliForm Manager allows the system administrator to accomplish the following: enter questions; specify all possible answers and in which order they will appear; create a question group; specify which questions belong in a group and in which order they will appear; create a section; specify which groups belong in a section and in which order they will appear; create a form; specify which sections belong in a group and in which order they will appear.

STORED PROCEDURES include:

PackageList—which returns all packages for a supplied user_id, that the user_id has access rights to. If user_id is 0, the proc will return all packages.

Formlist—which returns all forms for a given package_id. If package_id is 0, the proc will return all packages.

Sectionlist—which returns all sections for a given form_id. If form_id is 0, the proc will return all sections.

Getquestions—which returns all questions and associated question information belonging to the group specified by the input parameter group_id. If there are any saved responses, this proc will return them with the question for the user and prospect specified. If group_id is 0, the proc will return all questions.

Savequestion—which saves the response of a question to the response_data table. The procedure checks to see if a response to the question is already saved in the table. If it is, the response is modified. Otherwise, the response is added.

The form manager system of the invention is driven by tables (FIGS. 3(a) and 3(b)) which provide the flexibility in applying the forms manager to new business types as well as facile modifications of existing business types.

The Question table contains one entry for each question that can be displayed. Parameters useful to create the table question include: Q_id, an integer, and Q_id_P1 PRIMARY KEY, referring to a unique identifier for each question; Q_text, referring to the text of a question to be displayed; Q_explanation, referring to the text used for a help pop-up; Q_Type_id, an integer referring to a question type identifier; and, Q_notes, referring to the text used for internal comments about a question. Two identical questions each having a different Q_type_id must be entered twice.

The ANSWER table contains an entry for each possible choice in a set of answers for a question. For example, if question 23 has five choices, each of the five choices would be an entry in this table. Parameters used to create the answer table include: A_id, an integer, and A_id_P1, referring to a unique identifier for each answer; A_text, referring to an answer text to display; A_explanation, referring to the text used for a help pop-up; and, A_notes, referring to text used for internal comments about a question.

The GROUP table specifies a set of questions that are presented together. Parameters used to create table groups include: group_id, an integer, and group_id_P1, referring to a unique identifier for each group; group_name, referring to an internal name of a group; group_header, referring to the text to be displayed at the top of the group; and, group_notes, referring to text used for internal comments about the group.

The SECTION table defines a set of groups that are presented together. Parameters used to create the section table include: section_id, an integer, and section_id_P1, referring to a unique identifier for each section; section_name, referring to the internal name of a section; section_header, referring to text to be displayed at the top of a section; and, section_notes, referring to text used for internal comments about a section.

The FORM table consists of a set of Sections and comprises a complete application unit. Parameters used to create the form table include: form_id, an integer, and form_id_P1, referring to a unique identifier for each form; form_name, referring to an internal name of a form; form_header, referring to the text to be displayed at the top of a form; and, form_notes, referring to the text used for internal comments about a form.

The PACKAGE table consists of a set of forms which are sometimes presented together. Parameters used to create the Package table include: package_id, an integer, and package_id_P1, referring to a unique identifier for each package; package_name, referring to an internal name of a package; package_header, referring to text to be displayed at the top of a package; package_order, an integer referring to the order of package presentation; and, package_notes, referring to text used for internal comments about a package.

The Q_A table associates all the possible answers for a question. The table contains one entry for each answer to a question. Parameters used to create Q_A table include: Q_id, an integer and a foreign key (referencing another table), referring to a question identifier; A_id, an integer and a foreign key (referencing another table), referring to an answer identifier; and, A_order, an integer referring to the order of answer presentation.

The group_question table associates all the questions in a group to the group. There is one entry for each question in a group. Parameters used to create the group_question table include: group_id, an integer and a foreign key (referencing another table), referring to a group identifier; Q_id, an integer and a foreign key (referencing another table), referring to a question identifier; Q_preliminary, referring to a binary character which is set if this question is asked on initial presentation of the form; Q_required, an integer which is set to 0 if not required, 1 if required for saving, or 2 for submission; and, Q_order, an integer referring to the order of question presentation.

The section_group table associates all the Groups in a section to the section. There is one entry for each group in a section. Parameters used to create the section_group table include: section_id, an integer and a foreign key (referencing another table), referring to a section identifier; group_id, an integer referring to a group identifier; group_order, an integer referring to the order of a group presentation; group_repeat, a bit which is set if the group is a repeating group, whereby the program will display a button which will display another identical group of questions with an updated sequence number; and, repeat_question, referring to a question to be asked to get the number of group repeats.

The form_section table associates all the sections in a form to the form. There is one entry for each section in a form. Parameters used to create the form_section table include: form_id, an integer referring to a form identifier, section_id, an integer referring to a section identifier; and, section_order, an integer referring to the order of section presentation.

The package_form table associates all the forms in a package. There is one entry for each form in a package. Parameters useful to create table package_form include: package_id, an integer defining the package identity; form_id, an integer referring to the form identifier; and, form_order, an integer referring to the order of form presentation. The package_id of 0 is a special purpose package that contains all of the forms, and is used to list all the forms.

The Q-type table contains entries that define all the different question type/format combinations. Parameters useful for creating the table Q_type include: Q_type_id, an integer; Q_type_id_P1 PRIMARY KEY, referring to the type identifier; type_name, referring to the name this question type is called; type, referring to a field type, namely, one of the following: text, textarea, checkbox, listbox, or radiobox. Other parameters include: rows (for textarea), referring to the number of lines; cols, an integer referring to the number of columns for textbox and textarea; format_hint, referring to a format hint to be displayed to user to show the expected format; validation, referring to the name of a function used to validate this format; format, referring to the format of text input; lower, referring to the lower limit of text input; upper, referring to the upper limit of text input; multiselect, a bit set to ‘true’ if multiple answers can be selected; orientation, referring to the orientation of checkbox and radio button (‘H’ for horizontal, ‘V’ for vertical); and, q_type_notes, containing text.

The response_data table stores all the information entered on forms byusers. In the case of a repeating group, the q_rep value will be incremented for each repetition. In the case of a multiselect, an entry will be made for each answer selected. To create the table response_data, the following parameters are useful: app_id, an integer referring to an application identifier; package_id, an integer referring to a package identifier; form_id, an integer referring to a form identifier; section_id, an integer referring to a section identifier; group_id, an integer referring to a group identifier; Q_id, an integer referring to a question identifier; Q_rep, an integer referring to a question repetition count; A_id, an integer referring to an answer identifier, if question is multi-choice; A_text, referring to an answer text, if answer is a text-box or text-area; timestamp;datetime, referring to the datetime this entry was last modified; and, submit_app, a bit which indicates if this question was submitted.

The q_dependency table defines dependency conditions which determine when a question should not be displayed. The identifiers are required to define the particular question whose dependency is being established.

A_operator is the comparison operator used to compare the actual answer given to the Q_depend_on question with the answer (A_id or A_text) that will cause the Q_id not to be displayed. To create the table q_dependency, the following parameters are needed: package_id, an integer referring to package identification; d_form_id, an integer referring to the form identifier of a dependent question; d_section_id, an integer referring to the section identity of a dependent question; d_group_id, an integer referring to the group identifier of a dependent question; d_q_id, an integer referring to the identification of a question to be asked (i.e., a dependent question); line_num;an integer referring to a form identifier of the base question; b_section_id, an integer referring to a section identifier of the base question; b_group_id, an integer referring to a group identifier of the base question; b_q_id b_q_id, an integer referring to an identifier of the base question whose answer will determine if this question is asked; A_operator, an operator used to compare the actual answer to Q-depend_on question with the answer that will make question q_id not appear; an integer referring to an answer if q_depend_on is a multi-choice; A_fill, a parameter referring to an answer if q_depend_on is a text-box or text-area; and, logic_op, referring to a logical operator to connect two expressions (OR, AND or END (for end).

The temp-dependency table is a temporary table used to store dependency information while a dependency expression is being composed. After it is completed and validated, it is copied to q_dependency and deleted from this table. In order to create the table temp_dependency, the following parameters are needed: package_id, an integer referring to package identity; d_form_id, an integer referring to the form identifier of a dependent question; d_section_id, an integer referring to the section identity of a dependent question; d_group_id, an integer referring to the group identifier of a dependent question; d_q_id, an integer referring to the identification of a question to be asked (i.e., a dependent question); line_num; b_form_id, an integer referring to a form identifier of the base question; b_section_id, an integer referring to a section identifier of the base question; b_group_id, an integer referring to a group identifier of the base question; b_q_id, an integer referring to an identifier of the base question whose answer will determine if this question is asked; A_operator, an operator used to compare the actual answer to Q-depend_on question with the answer that will make question q_id not appear; A_id, an integer referring to an answer if q_depend_on is a multi-choice; A_fill, a parameter referring to an answer if q_depend_on is a text-box or text-area; and, logic_op, referring to a logical operator to connect two expressions (OR, AND or END) (for end).

The Package_dependency table is a table used to store package dependency information on the state selected. Parameters used to create the table package_dependency include: package_id, referring to a package identifier that is dependent; line_num, referring to a line number of an expression; prefix, referring to an open parenthesis if this is the beginning of a logical expression; A_operator, referring to an operator used to compare a state to a base state; b_state_abbr, referring to a base state; suffix, referring to a close parenthesis, if this is the end of a logical expression; and, logic_op, referring to a logical operator to connect two expressions, e.g., OR, AND or END (for end).

The temp_package_dependency table is a temporary table used to store package dependency information while a dependency expression is being composed. After it is completed and validated, it is copied to package_dependency and deleted from this table. Parameters used to create the table temp_package_dependency include: package_id, a package identifier that is dependent; line_num, referring to the line number of an expression; prefix, referring to an open parenthesis, if this is the beginning of a logical expression; A_operator, referring to an operator used to compare a state to a base state; b_state_abbr, referring to a base state; suffix, referring to a close parenthesis, if this is the end of a logical expression; and, logic_op, referring to a logical operator to connect two expressions, e.g., OR, AND or END (for end).

The ORG table contains information about an organization. An ORG is a set of user groups that make up a company or other business entity. Parameters used to create the table org include: org_id and org_id_P1 PRIMARY KEY, referring to organizational identity; org_password, referring to a password to enable access to an entire organization; org_name; and, org_notes.

The USERGROUP table contains information about user groups. A user group is a logical grouping of users that have the same package access rights. Parameters used to create the table usergroup include: usergroup_id and usergroup_id_P1 PRIMARY KEY referring to the usergroup identity, org_id referring to the organizational identity this usergroup belongs to, usergroup_password (the password to enable access to the entire group), usergroup_name and usergroup_notes.

The USERS table contains the particulars of each individual user of the system. Parameters used to create the table of users include: user_id and user_id_P1 PRIMARY KEY referring to the unique user identity, usergroup_id referring to the usergroup this user belongs to, user_password, referring to an encrypted user password; user_name, referring to a unique username; user_notes; usergroup_rights (which is set to 1 if a user has view rights to his entire usergroup and set to 2 if a user has view and modify rights to usergroup); admin_rights, a bit which is set if user has rights to use the Form Management Utility; first_name; last_name; business_name; email_address; address1; address2; city; state; and, zip.

The PROSPECT table contains a record for each subject of the forms. Parameters used to create the table prospect include: prospect_id and prospect_id_P1 PRIMARY KEY, first_name, last_name, business_name, email_address, address1, address2, city, state and zip.

The APP table stores information particular to an individual application for submittal. Relevant parameters to create an application table app include: app_id referring to the application identity; user_id referring to the user identity; prospect_id referring to the prospect identity; state_abbr referring to the state this application is intended for; package_id referring to the form package identity; timestamp; and, datetime, referring to the datetime this entry was last modified.

The STATES table contains information on states of the US. Parameters used to create the states table include state_name, referring to the full name of state; state_abbr and state_abbr_P1 PRIMARY KEY two character abbreviation of a state; and state_code (other code used for state).

The PACKAGE_ACCESS table defines which usergroups have access to which packages, and contains an entry for each package that a usergroup has access to. Parameters used to create the table package_access include: usergroup_id and package_id, both integers.

The VAL_FUNCTION table contains the validation functions that are used to verify the user data that is entered on a form. Parameters used to create the table val_function include: validation and validation_P1 PRIMARY KEY referring to the name of the validation function to be called; function_descrip referring to a description of the validation function to be displayed; and, function_text referring to the actual text of a javascript function. One row is inserted with all blanks into val_function so the “blank” choice will appear in the select-box.

The GEN_ID table is used to generate sequential numbers which are used as primary keys for tables. Relevant parameters for creating table gen_id include table_name, referring to the name of the table; and id_num, an integer referring to the last unique sequential number issued.

The formelementmap table stores replacement form element names to be used for exporting or redirecting answers to a package's questions to another external application from intelliform.asp. For example, if a user has questions “First Name, Last Name” and “Address,” in a package, and wished to do something else with these answers, rather than merely save them, the user may click on “pass to external.” Since the external program is expecting these answers to be passed with the questions having form element names (fname, Iname, addrs), instead of what the IntelliForm generated form element names would be, which would be of the form “q12repg323”, or the like. Such an approach uses the Map Form Element (outgoing) mapping utility, comparable to the map querystring for importing data.

The messages table is used for storing data for the IntelliForm Inbox functionality, which permits “request for information” interaction between the administrator and the user. For example, if the user fills in and submits an application and then the administrator reviews the application and sees that something was incorrectly filled out, the administrator has the capability of sending a message via IntelliForm inbox or email, or both, to the user who submitted the application. The user then may log in and respond, as appropriate.

The portals table is used by the system administrator to make the portals of the navigation menu, and is also automatically connected with userportalrights as a security tool. Portals are at the top level of hierarchy of the navigation menu, the next lowest levels being subportals, described below, and asppages.

The regexp table is a library of commonlly used Validation Formats. The system administrator has exclusive capability of adding, updating and deleting fields.

The subportals table contains the subportals that are under the portals in the navigation menu.

The Superadminsettings table is used by the system administrator, and permits the option of entering a debugging mode.

The temp_questions table is used to temporarily store questions that are to be used in the Form Migration Functionality. Prior to the actual addition of the questions to the real question table, they are stored here in case the user should change his mind in the middle of the form migration process.

The Userpagerights table is used to store those asppages of each portal(s) to which each user has access

The Userportalrights table is used to store those portal(s) to which each user has access.

Many modifications and other embodiments of the invention will come to the mind of the skilled worker in the art having the benefit of the teachings presented in the foregoing descriptions and the associated drawings. Therefore, it is to be understood that the invention is not to be limited to the specific embodiments disclosed herein, and that modifications and embodiments are intended to be included within the scope of the dependent claims.

What is claimed is:

1. A database-driven form manager for building and modifying a form for use in an internet, intranet or extranet environment, comprising
means for storing a question in a table of questions;
means for storing properties of each respective question, said properties including a text for the question and a reference number denoting its question type;
means for storing a group of said questions;
means for storing properties of the group of questions, said properties including a group name, an order parameter denoting the order of said questions and a reference number denoting group identification;
means for referencing association of each question with each respective group, said means being a group question table, wherein said group question table contains a set of group identifications and associated question identifications;
means for selecting questions and associating said questions with a group;
means for re-ordering said questions within each associated group based on a group order parameter so as to build or modify said form;
means for looping through group questions to extract questions belonging to the group identification; and
means for displaying said form on a display device for use in an internet, intranet or extranet environment.

2. The database-driven form manager in accordance with claim 1, wherein the question identification types comprise text-box, pull-down, list-box, check-box, radio-button or text area.

3. The database-driven form manager in accordance with claim 2, wherein the text area denotes a question identification type having multiple rows of data.

4. The database-driven form manager in accordance with claim 1, wherein the question identification type refers to a type of question.

5. The database-driven form manager in accordance with claim 1, wherein the properties of questions further comprise an explanation or help text, a note or notes comprising at-will comments, and/or an indication of whether the question is required to be answered.

6. The database-driven form manager in accordance with claim 1, further comprising means for entering answers to the questions.

7. The database-driven form manager in accordance with claim 6, further comprising means for saving or storing said answers to questions.

8. The database-driven form manager in accordance with claim 1, further comprising means for selecting possible answers based on expected answer properties.

9. The database-driven form manager in accordance with claim 8, wherein said answer properties comprise an answer identification, associated answer identification, answer text and answer text parameters.

10. The database-driven form manager in accordance with claim 9, wherein said properties are stored in a question/answer table.

11. The database-driven form manager in accordance with claim 1, further comprising a means for associating one or more second form elements with one or more other first form elements, said first form elements being selected by the user priorly to said second form elements, and means for causing said one or more second form elements to be displayed upon the input by the user of said one or more first form elements.

12. The database-driven form manager in accordance with claim 1, further comprising a means for validating the format of an answer, comprising a means of associating with the form elements of the data comprising said answer the type of data and other appropriate answer properties, and a means of confirming the correctness of each form element so as to permit verification of data purity or validity.
